(19) United States
(12) Patent Application Publication
(10) Pub. No.: US 2013/0343968 A1
(43) Pub. Date: Dec. 26, 2013

(54) PACKAGING STRUCTURE

(71) Applicant: FUJIFILM Corporation, Tokyo (JP)

(72) Inventor: Yuzuru OOTSUKA, Kanagawa (JP)

(73) Assignee: FUJIFILM Corporation, Tokyo (JP)

(21) Appl. No.: 13/974,711

(22) Filed: Aug. 23, 2013

Related U.S. Application Data
(63) Continuation of application No. PCT/JP2012/056189, filed on Mar. 9, 2012.

(30) Foreign Application Priority Data
Mar. 31, 2011 (JP) 2011-079584

(51) Int. Cl. B01L 3/00

(52) U.S. Cl. CPC B01L 3/00
USPC 422/555

(57) ABSTRACT

The present invention provides a packaging structure, which includes a plurality of dry analytical elements that are stacked on top of one another in a thickness direction; a packaging bag into which the dry analytical elements are placed and that is separable in two along a planar direction of the dry analytical elements; and protective sheets that are placed in between the dry analytical elements and that are each fixed, at one end, to one side of the packaging bag that is separable in two.

### CROSS-REFERENCE TO RELATED APPLICATION

This application is a continuation application of International Application No. PCT/JP2012/056189, filed Mar. 9, 2012, the disclosure of which is incorporated herein by reference in its entirety. Further, this application claims priority from Japanese Patent Application No. 2011-079584, filed Mar. 31, 2011, the disclosure of which is incorporated herein by reference in its entirety.

### BACKGROUND

1. Technical Field

The present invention pertains to a packaging structure and particularly relates to a packaging structure that can be suitably applied to packaging dry analytical elements used in blood tests and so forth.

2. Related Art

When dry analytical elements used in blood and urine tests are exposed to open air, measurement performance deteriorates due to the effects of airborne moisture, oxygen, and sunlight, so until the dry analytical elements are used for measurement, they are packaged in a moisture-proof and light-blocking film and kept in a moisture-proof and light-blocked state so that measurement performance does not deteriorate.

Ordinarily, one dry analytical element is used for one test item, and in the case of performing a blood test in regard to plural test items, it is common to combine different dry analytical elements in accordance with the test items. In an ordinary blood test, the test items are each fixed, so if dry analytical elements corresponding to test items can be combined and placed into a single package, this makes it convenient for placing the dry analytical elements into a biochemical analyzer.

However, when different dry analytical elements are stored in a single package, performance drops because of interference. Thus, conventionally, dry analytical elements have been packaged in individual packages or packaged in a multiple package to prevent interference between the dry analytical elements.

As an example of packaging dry analytical elements in a multiple package, there is a multiple package in which plural packages, each having one dry analytical element individually packaged therein in an airtight state, are continuously lined up, wherein: the multiple package is configured by joining together a housing section forming material on which individual dry analytical elements are continuously lined up and a long upper cover forming material that covers the housing section forming material; a starting end portion that does not house a dry analytical element is disposed on one lengthwise direction end of the upper cover forming material; a region where the housing section forming material and the upper cover forming material are partially not joined together is formed in the starting end section; and the housing section forming material and the upper cover forming material can be detached from one another starting at the region where the housing section forming material and the upper cover forming material are partially not joined together (Japanese Patent Application Laid-open (JP-A) No. 8-201371).

Further, there are also cases where compatibility is achieved by storing a predetermined combination of dry analytical elements in a single package and allowing, to a certain extent, a drop in performance resulting from interference between the dry analytical elements.

As an example of this kind of package, there is also a packaging structure where a plastic cartridge, into which a predetermined number (e.g., 50) of different dry analytical elements have been placed, is stored in a sealed bag lined with foil (Japanese Patent No. 3,696,650).

Multiple packaging of dry analytical elements has the problem that, because the dry analytical elements must be taken out one at a time and placed into a biochemical analyzer, it takes time and effort to place the dry analytical elements into an automatic analyzer.

On the other hand, in a packaging structure where a predetermined combination of dry analytical elements are stored in a single package, a drop in performance caused by interference between the dry analytical elements can be prevented by interposing protective sheets between the dry analytical elements, but there arises the problem that removing the protective sheets is burdensome and takes time and effort.

### SUMMARY

The present invention has been made in order to solve the above problem and provides a packaging structure that does not require time and effort to remove dry analytical elements one at a time and load them into a biochemical analyzer or time and effort to remove protective sheets one sheet at a time and can prevent a drop in performance caused by interference between different dry analytical elements.

A packaging structure of a first aspect of the present invention comprises: plural dry analytical elements that are stacked on top of one another in a thickness direction; a packaging bag into which the dry analytical elements are placed and that is separable in two along a planar direction of the dry analytical elements; and protective sheets that are placed in between the dry analytical elements and are that each fixed, at one end, to one side of the packaging bag that is separable in two.

In the packaging structure of the first aspect, when the packaging bag is separated in two and then the section of the separated-in-two packaging bag on the side to which the protective sheets are each fixed is removed, the dry analytical elements remain in the remaining section of the packaging bag in the state in which the dry analytical elements remain stacked in the thickness direction.

A packaging structure of a second aspect of the present invention is the packaging structure of the first aspect, wherein each of the dry analytical elements has a sample permeation layer in its center, and a width of the protective sheets, which is a dimension in a direction orthogonal to a pull-off direction of the protective sheets, is larger than a width of the sample permeation layers and smaller than a width of the dry analytical elements.

The dry analytical elements sealed in the packaging structure of the second aspect are ordinarily stored in an analytical element storage holder of a biochemical analyzer and used. Additionally, the analytical element storage holder has four side walls that hold the stored dry analytical elements, and height direction cutout portions for allowing the dry analytical elements to be gripped with fingers and loaded are disposed in these side walls. Here, in the packaging structure of the second aspect, as mentioned above, the width of the protective sheets is larger than the width of the sample permeation layers and smaller than the width of the dry analytical elements. Consequently, the protective sheets can easily pass through the cutout portions of the side walls. Therefore, in this packaging structure, the loading procedure of housing, without separating in two, the packaging bag in the analytical element storage holder, then separating the packaging bag in two, pulling off the section of the packaging bag on the side to which the protective sheets are each fixed, and then removing the remaining section of the packaging bag can be implemented easily.

A packaging structure of a third aspect of the present invention is the packaging structure of the second aspect, further comprising a holding clip that holds the dry analytical elements in the state in which the dry analytical elements are stacked on top of one another in the thickness direction.

In the packaging structure of the third aspect, the state in which the dry analytical elements are arranged in a predetermined order in the thickness direction is held by the holding clip even in the state in which the packaging bag and the protective sheets have been removed.

A packaging structure of a fourth aspect of the present invention comprises: plural dry analytical elements that are stacked on top of one another in a thickness direction; a packaging bag into which the dry analytical elements are placed and that is separable in two along a planar direction of the dry analytical elements; a holding clip that holds the dry analytical elements in the state in which the dry analytical elements are stacked on top of one another in the thickness direction; and protective sheets that are placed in between the dry analytical elements and are that each fixed, at one end, to the holding clip.

In the packaging structure of the fourth aspect, by separating in two and removing the packaging bag, the dry analytical elements are taken out from the packaging bag in the state in which the dry analytical elements remain stacked in the thickness direction by the holding clip together with the protective sheets. When the dry analytical elements are then loaded into an analytical element storage holder of a biochemical analyzer in the state in which the dry analytical elements remain held by the holding clip and the holding clip is then pulled in a direction away from the analytical element storage holder and removed, the protective sheets are removed together with the holding clip, and the dry analytical elements are loaded in the analytical element storage holder in the state in which the dry analytical elements are arranged in a predetermined order in the thickness direction.

### BRIEF DESCRIPTION OF THE DRAWINGS

Exemplary embodiments of the present invention will be described in detail based on the following figures, wherein:

FIG. 1 is a perspective view showing the outer appearance of a packaging structure pertaining to embodiment 1;

FIG. 2 is a cross-sectional view showing a cross section in which the packaging structure shown in FIG. 1 has been cut along plane A-A in FIG. 1;

FIG. 3 is a perspective view showing the positional relationship between dry analytical elements and protective sheets placed into the packaging structure pertaining to embodiment 1;

FIG. 4 is a perspective view showing the outer appearance of another example of the packaging structure pertaining to embodiment 1;

FIG. 5A is a plan view showing the structure of the dry analytical elements placed into the packaging structure pertaining to embodiment 1;

FIG. 5B shows a cross-sectional view showing the structure of the dry analytical elements placed into the packaging structure pertaining to embodiment 1;

FIG. 6 is a perspective view showing a state in which a packaging bag has been separated in two in the packaging structure pertaining to embodiment 1;

FIG. 7A is a cross-sectional view showing a state before separating the packaging bag in two in the packaging structure pertaining to embodiment 1;

FIG. 7B is a cross-sectional view showing a state in which the packaging bag has been separated in two in the packaging structure pertaining to embodiment 1;

FIG. 7C is a cross-sectional view showing a state in which the packaging bag and the protective sheets have been removed in the packaging structure pertaining to embodiment 1;

FIG. 8 is a perspective view showing the packaging bag having been separated in two in a state in which the packaging structure of embodiment 1 is stored in an analytical element storage holder;

FIG. 9A is a perspective view showing the outer appearance of a packaging structure pertaining to embodiment 2;

FIG. 9B shows a cross-sectional view in which the packaging structure pertaining to embodiment 2 has been cut along plane A-A in FIG. 9A;

FIG. 10 is an explanatory drawing showing a packaging bag being separated in two along a perforation and the side of the separated-in-two packaging bag to which the protective sheets are each fixed being removed in the packaging structure pertaining to embodiment 2;

FIG. 11 is a cross-sectional view showing the configuration of another example of a packaging structure pertaining to embodiment 3 and shows a packaging bag having been separated in two at a perforation; and

FIG. 12 is a perspective view showing a holding clip of the packaging structure being removed together with the protective sheets in a state in which the packaging structure pertaining to embodiment 3 is loaded into an analytical element storage holder of a biochemical analyzer.

### DETAILED DESCRIPTION

### 1. Embodiment 1

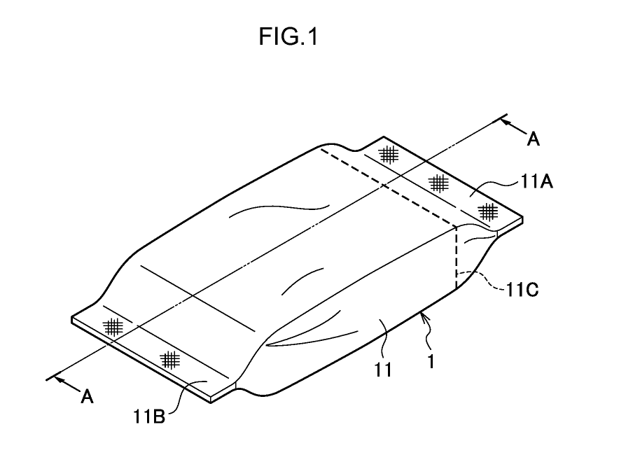

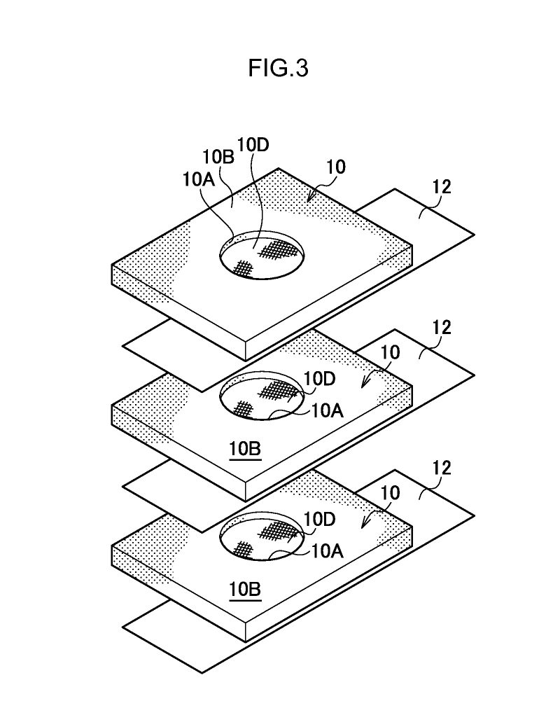

An example of a packaging structure pertaining to the present invention will be described below using the drawings. As shown in FIGS. 1 to 3, a packaging structure 1 pertaining to embodiment 1 is equipped with a packaging bag 11 into which plural (e.g., three) dry analytical elements 10 stacked on top of one another in a thickness direction are placed and protective sheets 12 that are interposed between the dry analytical elements 10.

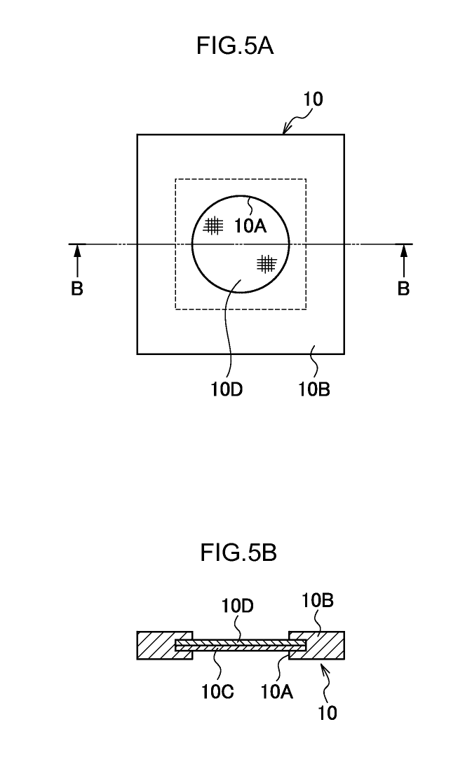

The dry analytical elements 10 are for being loaded into a biochemical analyzer and biochemically analyzing blood and urine; as shown in FIGS. 5A and 5B, each of the dry analytical elements 10 has a plastic substrate 10B, which has a rectangular or square planar shape and in the center portion of which is formed a circular open portion 10A, and a reagent layer 10C and a sample permeation layer 10D, which are embedded in the position in the substrate 10B where the open portion 10A is formed.

The reagent layer 10C comprises filter paper, woven cloth, or nonwoven cloth that has been dipped in a reagent that reacts with a specific component (e.g., glucose) in blood or urine and produces a color. The sample permeation layer 10D is a layer that is layered on the reagent layer 10C and is for allowing a sample of blood or urine to be chemically analyzed to permeate it, and the sample permeation layer 10D is formed from a material that an aqueous liquid such as blood or urine can permeate, such as filter paper, woven cloth, or nonwoven cloth.

The packaging bag 11 can be formed from a composite sheet in which a sheet of an oxygen-impermeable resin such as ethylene-vinyl alcohol copolymer resin, aliphatic polyamide resin, or vinylidene chloride/vinyl acetate copolymer resin and metal foil such as aluminum foil are layered on a sheet of a water vapor-impermeable resin such as low-density polyethylene resin, polypropylene resin, or ethylene-propylene copolymer resin. Further, a light-blocking layer such as a black layer may also be disposed as needed.

The protective sheets 12 are sheet member whose width is larger than the diameter of the open portions 10A of the dry analytical elements 10 but smaller than the width of cutout portions 21 of an analytical element storage holder 20 in the biochemical analyzer into which the dry analytical elements 10 are to be placed, and the protective sheets 12 are formed by a material capable of being heat-sealed to the packaging bag 11. Examples of materials for the protective sheets 12 include low-density polyethylene resin, polypropylene resin, ethylene/propylene copolymer resin, ethylene/vinyl alcohol copolymer resin, aliphatic polyamide resin, and vinylidene chloride/vinyl acetate copolymer resin, but materials for the protective sheets 12 are not limited to these materials provided that they can prevent interference between the reagent layers 10C of the dry analytical elements 10 and that the protective sheets 12 slide well on the substrates 10B.

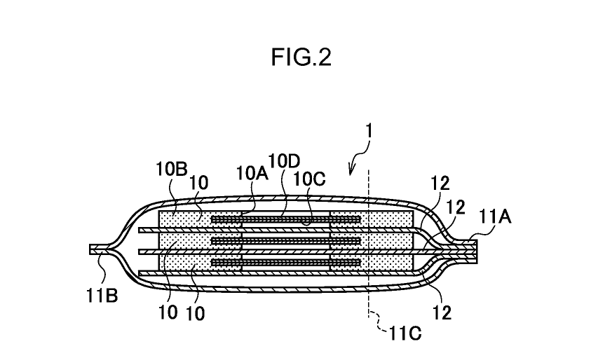

As shown in FIG. 1 and FIG. 2, one end edge of the packaging bag 11 is a heat-sealed portion 11A together with which the protective sheets 12 are heat-sealed, and the other end edge of the packaging bag 11 is a heat-sealed portion 11B to which the protective sheets 12 are not heat-sealed.

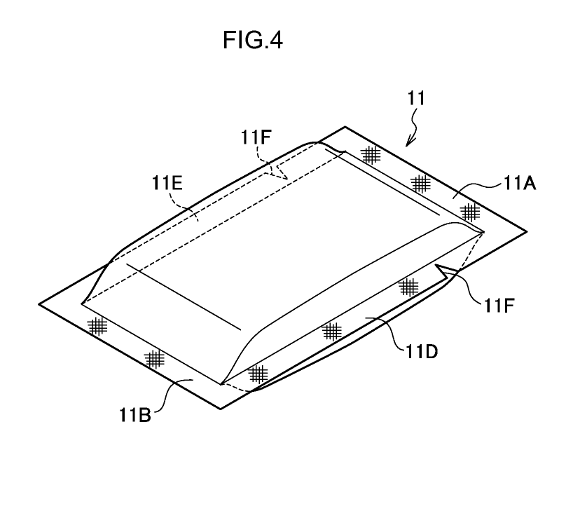

A perforation 11C for separating the packaging bag 11 in two along a planar direction of the dry analytical elements 10 is formed in the neighborhood of the heat-sealed portion 11A of the packaging bag 11. Instead of disposing the perforation 11C in the packaging bag 11, as shown in FIG. 4, both side edge portions of the packaging bag 11 may also be heat-sealed to form a heat-sealed portion 11D and a heat-sealed portion 11E, and notches 11F for separating the packaging bag 11 in two may also be formed in the heat-sealed portions 11D and 11E.

The procedure of taking out the dry analytical elements 10 from the packaging structure 1 will be described below.

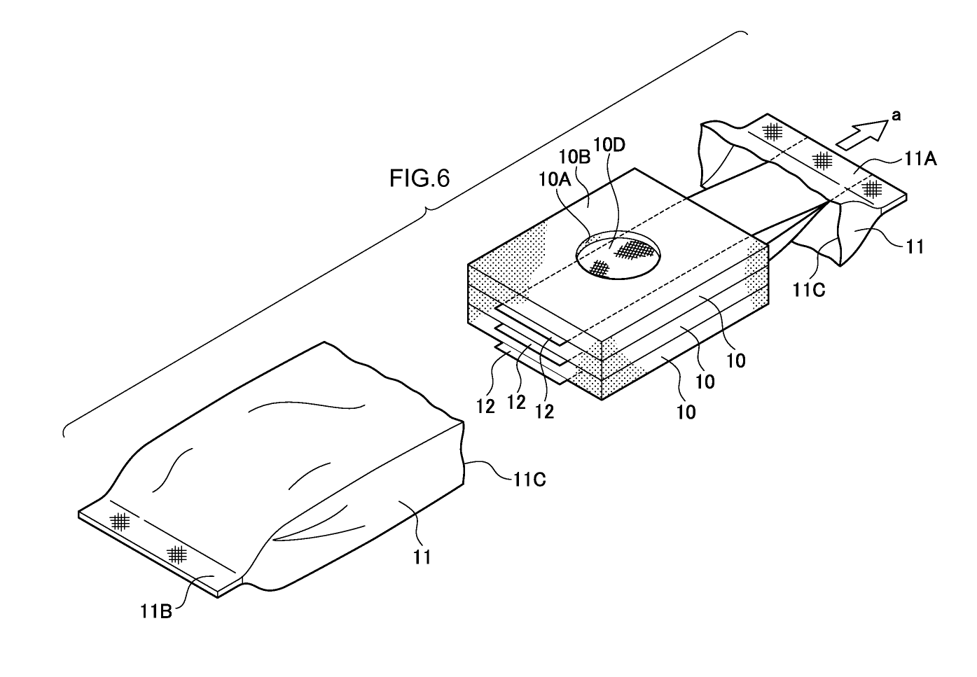

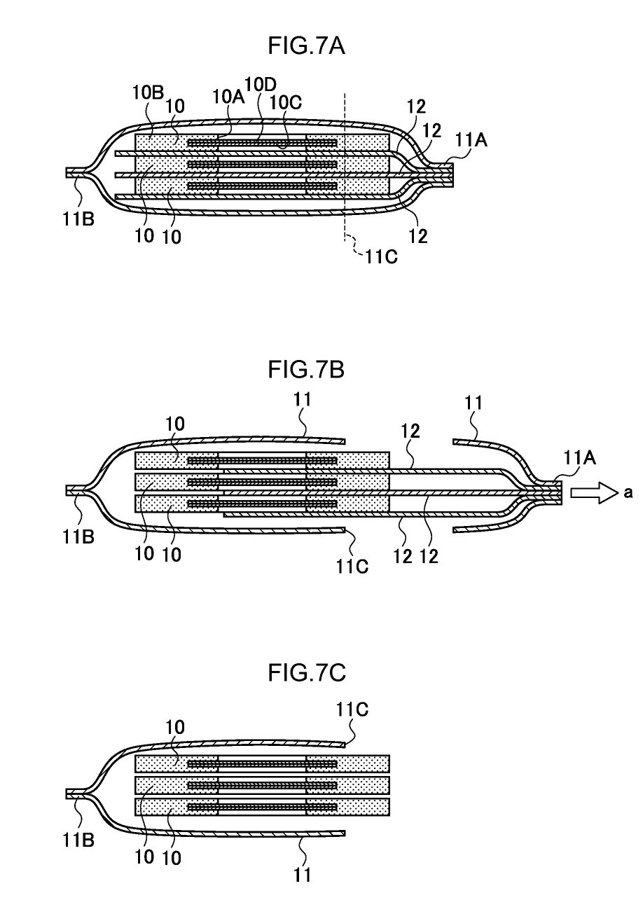

When the packaging bag 11 is separated in two at the position of the perforation 11 C and the heat-sealed portion 11A and the heat-sealed portion 11B are pulled in directions away from each other as indicated by arrow a in FIG. 6 and FIG. 7B, the protective sheets 12 are removed from in between the dry analytical elements 10 together with the section of the packaging bag 11 on the side where the heat-sealed portion 11A is formed. Then, the dry analytical elements 10 remain in the remaining section of the packaging bag 11 with their arrangement in the thickness direction at the time of packaging being preserved as shown in FIG. 6 and FIG. 7C.

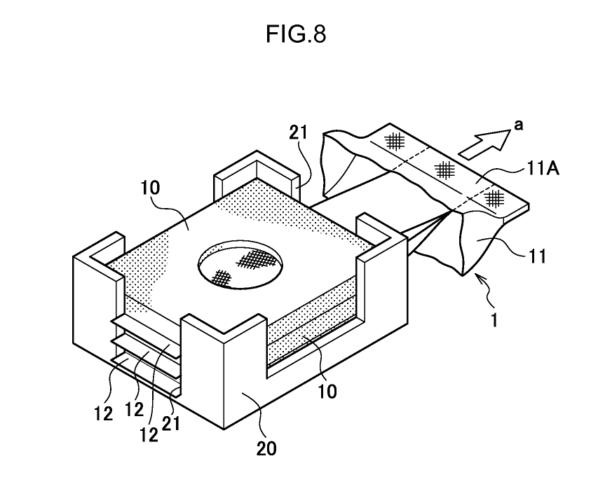

The width of the protective sheets 12—that is, the dimension in the direction orthogonal to direction a in which the packaging bag 11 is pulled and removed in FIGS. 6 to 8—is smaller than the width of the cutout portions 21 of the analytical element storage holder 20 as mentioned above. Consequently, as shown in FIG. 8, by placing the packaging structure 1 into the analytical element storage holder 20 in the state in which the packaging bag 11 is not separated in two, then separating the packaging bag 11 in two at the perforation 11C, pulling the heat-sealed portion 11A in the direction of arrow a, and removing the packaging bag 11, the dry analytical elements 10 can be placed into the analytical element storage holder 20 with their arrangement in the thickness direction at the time of packaging being persevered.

2. Embodiment 2

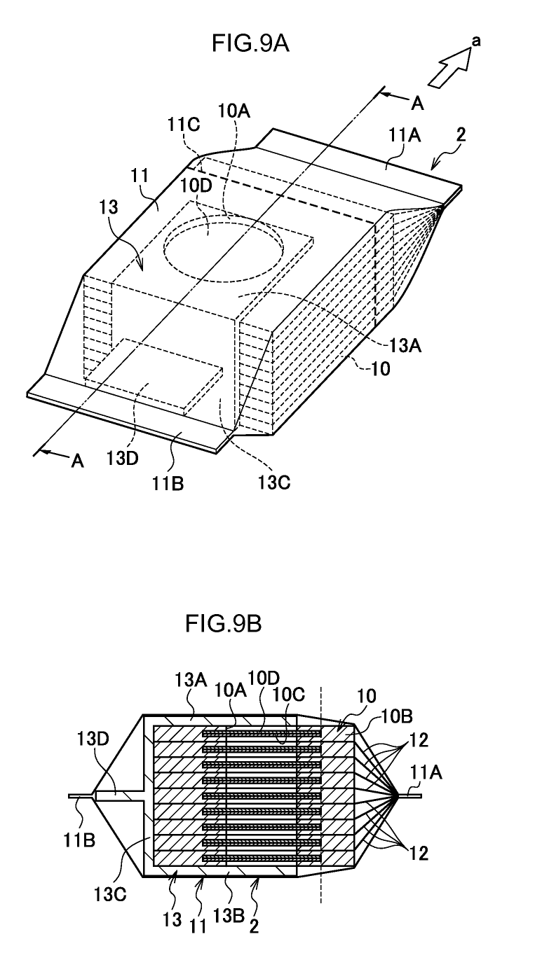

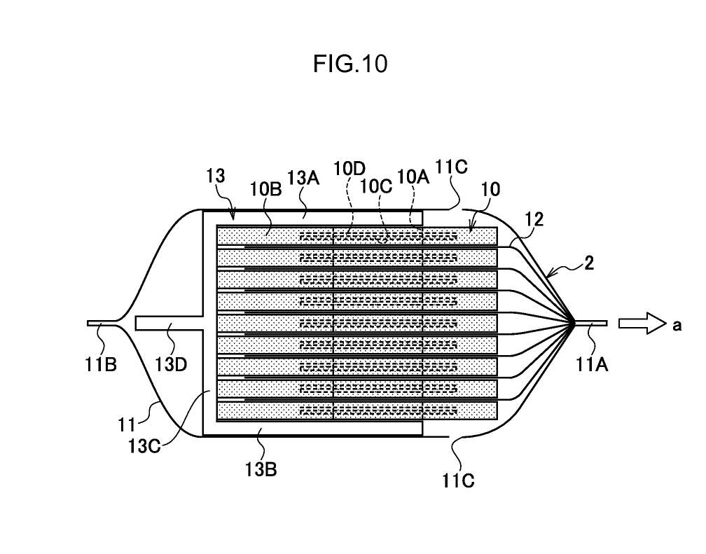

Another example of a packaging structure pertaining to the present invention will be described below using the drawings. As shown in FIG. 9A, FIG. 9B, and FIG. 10, a packaging structure 2 pertaining to embodiment 2 is equipped with a packaging bag 11 into which plural (e.g., nine) dry analytical elements 10 stacked on top of one another in a thickness direction are placed, protective sheets 12 that are interposed between the dry analytical elements 10, and a clamp-like holding clip 13 that holds the dry analytical elements 10 and the protective sheets 12 in the state in which the dry analytical elements 10 and the protective sheets 12 are stacked on top of one another in the thickness direction.

The dry analytical elements 10, the packaging bag 11, and the protective sheets 12 are as described in embodiment 1.

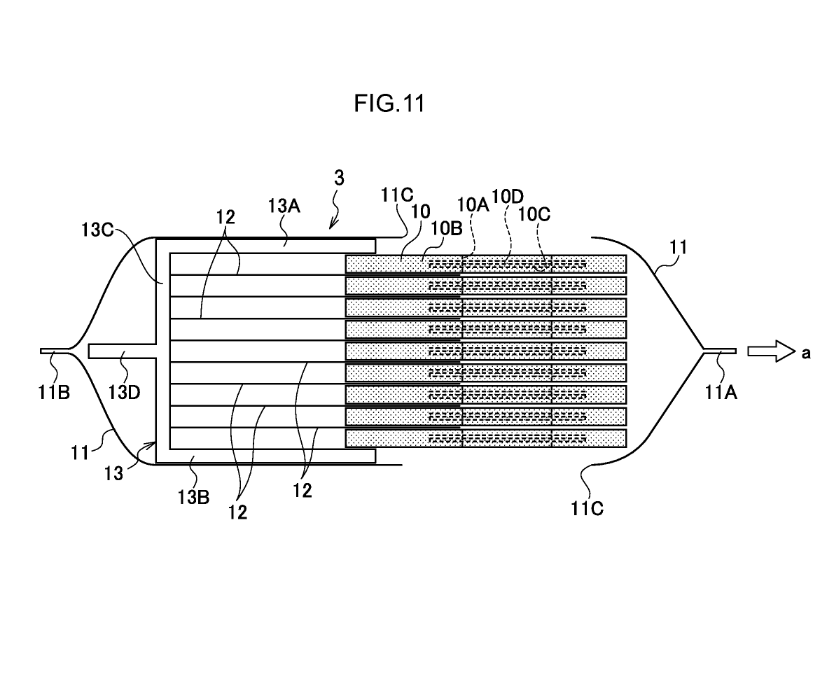

As shown in FIG. 9A and FIG. 9B, and FIG. 10 and FIG. 11, the holding clip 13 is equipped with an upper-side cover plate 13A that contacts the surface of the stack of dry analytical elements 10 that becomes the upper side when the stack is loaded into the analytical element storage holder 20 (i.e., the surface on the side where the sample permeation layer 10D is formed), a lower-side cover plate 13B that contacts the surface of the stack of dry analytical elements 10 that becomes the lower side when the stack is loaded into the analytical element storage holder 20 (i.e., the surface on the side where the reagent layer 10C is formed), and an intermediate plate 13C that interconnects one end edge of each of the upper-side cover plate 13A and the lower-side cover plate 13B. The holding clip 13 is formed in the shape of a substantially square “U”, as seen from a direction orthogonal to the removal direction a of the packaging bag 11, by the upper-side cover plate 13A, the lower-side cover plate 13B, and the intermediate plate 13C. A handle 13D is disposed on, in such a way as to project from, the surface of the intermediate cover plate 13C on the opposite side of the side to which the upper-side cover plate 13A and the lower-side cover plate 13B are connected—that is, the surface of the intermediate cover plate 13C on the opposite side of the side facing the side edges of the dry analytical elements 10 when the holding clip 13 holds the dry analytical elements 10.

As shown in FIG. 10, the protective sheets 12 are heat-sealed together with the packaging bag 11 at one end edge of the packaging bag 11 to form the heat-sealed portion 11A.

The procedure of taking out the dry analytical elements 10 from the packaging structure 2 will be described below.

When the packaging bag 11 is separated in two at the position of the perforation 11 C and the heat-sealed portion 11A and the heat-sealed portion 11B are pulled in directions away from each other as indicated by arrow a in FIG. 10, the protective sheets 12 are removed from in between the dry analytical elements 10 together with the section of the packaging bag 11 on the side where the heat-sealed portion 11 A is formed. Then, the dry analytical elements 10 can be taken out from the packaging bag 11 in the state in which the dry analytical elements 10 are held in their arrangement in the thickness direction at the time of packaging by the holding clip 13.

The dry analytical elements 10 that have been taken out from the packaging bag 11 are loaded into the analytical element storage holder 20 in the state in which the dry analytical elements 10 are held in the holding clip 13. The holding clip 13 is removed after the stack of dry analytical elements 10 held in the holding clip 13 has been loaded into the analytical element storage holder 20, whereby the dry analytical elements 10 are loaded into the analytical element storage holder 20 in the state in which the dry analytical elements 10 are arranged in a predetermined order in the thickness direction.

### 3. Embodiment 3

Still another example of a packaging structure pertaining to the present invention will be described below using the drawings. As shown in FIG. 11, a packaging structure 3 pertaining to embodiment 3 is the same as the packaging structure 2 of embodiment 2 in that the packaging structure 3 is equipped with a packaging bag 11 into which plural (e.g., nine) dry analytical elements 10 stacked on top of one another in a thickness direction are placed, protective sheets 12 that are interposed between the dry analytical elements 10, and a clamp-like holding clip 13 that holds the dry analytical elements 10 and the protective sheets 12 in the state in which the dry analytical elements 10 and the protective sheets 12 are stacked on top of one another in the thickness direction.

However, what is different is that, instead of the protective sheets 12 being heat-sealed together with the packaging bag 11 at the heat-sealed portion 11A of the packaging bag 11, the protective sheets 12 are each fixed to the surface of the intermediate plate 13C of the holding clip 13 on the side facing the side edges of the dry analytical elements 10 when the holding clip 13 holds the dry analytical elements 10. Here, in FIG. 11, the packaging bag 11 is shown separated in two at the perforation 11 C in order to facilitate understanding, but in actuality, before the dry analytical elements 10 are taken out from the packaging bag 11, the packaging bag 11 of the packaging structure 3 is not separated in two at the perforation 11C but whole.

The procedure of taking out the dry analytical elements 10 from the packaging structure 3 of embodiment 3 and loading them into an analytical element storage holder 30 will be described below.

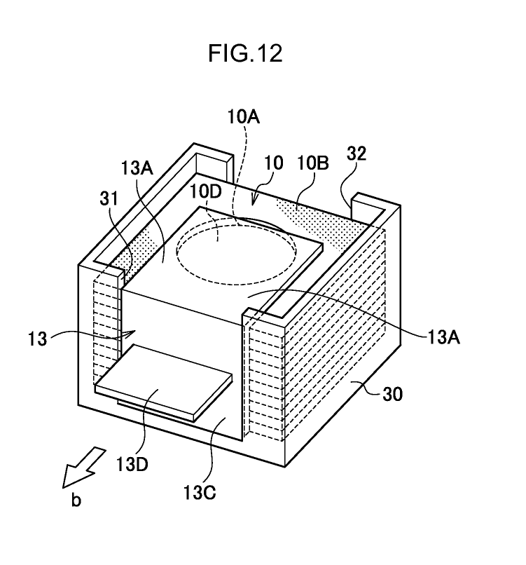

As shown in FIG. 12, the analytical element storage holder 30 has an analytical element housing chamber 32 in which the dry analytical elements 10 held in the holding clip 13 are housed, and a holding clip fitting portion 31, which is a cut portion into which the holding clip 13 is fitted in the state in which the dry analytical elements 10 are housed in the analytical element housing chamber 32, is formed in a side wall 33.

First, as shown in FIG. 11, the packaging bag 11 is separated in two at the perforation 11C and removed, and the dry analytical elements 10 held in the holding clip 13 are taken out. Then, as shown in FIG. 12, the dry analytical elements 10 that have been taken out from the packaging bag 11 are housed in the analytical element housing chamber 32 in such a way that the holding clip 13 is fitted into the holding clip fitting portion 31.

Then, when the handle 13D of the holding clip 13 is pulled in the direction of arrow b in FIG. 12, the protective sheets 12 are removed from in between the dry analytical elements 10 together with the holding clip 13 as shown in FIG. 11. In this way, the dry analytical elements 10 are loaded into the analytical element storage holder 30 in the state in which their arrangement in the thickness direction is held.

What is claimed is:

1. A packaging structure comprising:
a plurality of dry analytical elements that are stacked on top of one another in a thickness direction;
a packaging bag into which the dry analytical elements are placed and that is separable in two along a planar direction of the dry analytical elements; and
protective sheets that are placed in between the dry analytical elements and that are each fixed, at one end, to one side of the packaging bag that is separable in two.

2. The packaging structure according to claim 1, wherein each of the dry analytical elements has a sample permeation layer in its center, and a width of the protective sheets, which is a dimension in a direction orthogonal to a pull-off direction of the protective sheets, is larger than a width of the sample permeation layers and smaller than a width of the dry analytical elements.

3. The packaging structure according to claim 2, further comprising a holding clip that holds the dry analytical elements in the state in which the dry analytical elements are stacked on top of one another in the thickness direction.

4. A packaging structure comprising:
a plurality of dry analytical elements that are stacked on top of one another in a thickness direction;
a packaging bag into which the dry analytical elements are placed and that is separable in two along a planar direction of the dry analytical elements;
a holding clip that holds the dry analytical elements in the state in which the dry analytical elements are stacked on top of one another in the thickness direction; and
protective sheets that are placed in between the dry analytical elements and that are each fixed, at one end, to the holding clip.
